(19) United States
(12) Patent Application Publication
(10) Pub. No.: US 2009/0216596 A1
(43) Pub. Date: Aug. 27, 2009

(54) ESTIMATING ADVERTISEMENT PLACEMENT COSTS

(76) Inventor: Matthew Philip Berry-Smith, New South Wales (AU)

Correspondence Address: SNELL & WILMER LLP (OC), 600 ANTON BOULEVARD, SUITE 1400, COSTA MESA, CA, 92626, US

(21) Appl. No.: 12/090,143

(22) PCT Filed: Oct. 17, 2006
(86) PCT No.: PCT/AU2006/001535

§ 371 Date: Sep. 22, 2008

(30) Foreign Application Priority Data
Oct. 18, 2005 (AU) 2005905762

(51) Int. Cl. G06Q 10/00; G06Q 30/00; G06T 1/00

(52) U.S. Cl. 705/8; 705/14; 705/26; 345/619

(57) ABSTRACT

The invention concerns estimating advertisement placement costs, for example, the placement of an advertisement in a newspaper The invention allows users (18) to enter in text of an advertisement and to select a publication (66) in a website. The server (10) of the invention operates to automatically create an artwork (38) for placement using a pre-stored template 84 86. Using the dimensions of the artwork, the user (18) is presented with a cost estimate for placing the advertisement in that publication. Aspects of the invention include a method of estimating the cost of a placement of an advertisement in a publication, a computer system operable to estimate the cost of a placement of an advertisement in a publication and a web site that operates to provide an estimate of the cost of a placement of an advertisement in a publication.

### TECHNICAL FIELD

The invention concerns estimating advertisement placement costs, for example, the placement of an advertisement in a newspaper. The invention concerns a method of estimating the cost of a placement of an advertisement in a publication, a computer system operable to estimate the cost of a placement of an advertisement in a publication and a web site that operates to provide an estimate of the cost of a placement of an advertisement in a publication.

### BACKGROUND ART

Most publications include sections that are comprised of multiple advertisements. These sections can include but are not limited to the real estate, retail, motor vehicle and employment sections.

Budgets are often required in order to manage an advertising campaign. The cost of placing an advertisement in a publication is proportional to dimensions of the publication, that is the number of columns the artwork of the advertisement spans and its depth based on 0.5 cm or 1 cm increments.

### SUMMARY OF THE INVENTION

In a first aspect the invention provides a method of estimating the cost of a placement of an advertisement in a publication, the method comprising the steps of:
receiving text to be included in the advertisement;
receiving an indication that a stored template is to be used to create the artwork for the advertisement;
receiving an indication of the publication that the advertisement is to be placed in;
automatically creating the artwork by arranging the text in the template; and
using the depth dimension of the artwork created to calculate the estimate of the cost of placing the advertisement in the publication.

The artwork for an advertisement is usually created by an art department of a company and that department is separate to the department that is trying to calculate the budget for an advertising campaign that the advertisement is a part of. Using this invention, artwork for the advertisement is automatically created and used to create an estimate for the placement of the advertisement in the publication. Using the invention a budget for a campaign can be estimated without relying on the art department to create the artwork and without contacting that media representative.

The method may further comprise the steps of:
receiving amended text to be included in the advertisement;
automatically creating an amended artwork by arranging the amended text in the template; and
using the depth dimension of the created amended artwork to calculate an amended estimate of the cost of placing the advertisement in the publication.

The method may be repeated to create a further artwork of a further advertisement and to calculate a further estimate of the cost of placing the further advertisement in the same or a different publication. The method may then also comprise calculating a total estimate of the cost of the placement of the advertisement and the further advertisement.

The method may further comprise the step of receiving a booking order for placing the advertisement in the publication.

The step of receiving an indication of a stored template may be the selection of one or more stored templates. The templates may have varying widths based on number of columns.

The method may further comprise the step of upon request, automatically sending the artwork to the requestor for proofing.

The step of automatically creating the artwork may comprise automatically increasing the depth dimension of the created artwork as the amount of the received text substantially increases.

The method may further comprise using the width dimension of the artwork in the calculation of the estimate. The width may be measured in columns. The step of automatically creating the artwork may comprise automatically adjusting the width of the artwork to suit the actual width of the advertisement in the publication.

The step automatically creating the artwork may comprise automatically lengthening or shortening a graphic that extends the depth or width of the artwork. The step of lengthening or shortening a graphic may comprise the addition or removal of a padding object, or by overlapping padding objects.

The step of receiving an indication of the publication may include the selection of the publication from a list of publications. The indication of the publication may include the placement of the advertisement in multiple publications. The indication of the publication may include the selection of a section of the publication from a list of sections of the publication. The indication of the publication may include a day or days that the advertisement is to be placed. The indication of publication may include whether the placement is to be printed in colour.

The method may further comprise receiving amended publication information and automatically calculating an amended estimate of the cost of placing the advertisement in the amended publication using the amended publication indication.

The estimate may in fact be an accurate quote.

In a further aspect the invention provides a computer system operable to estimate the cost of a placement of an advertisement in a publication.

In yet a further aspect the invention provides a web site operable to provide an estimate of the cost of a placement of an advertisement in a publication.

### BRIEF DESCRIPTION OF THE DRAWINGS

An example of the invention will now be described in reference to the accompanying drawings in which:

FIG. 1 shows a schematic view of the computer system of the current invention;

FIG. 2 shows a simplified flowchart of the method of the current invention;

FIGS. 3 to 9 and 11 to 15 are sample screen displays that can be displayed to the user of the website of the current invention; and

FIGS. 10(a) to 10(f) schematically shows the method of automatically adjusting the width of an artwork.

### BEST MODES OF THE INVENTION

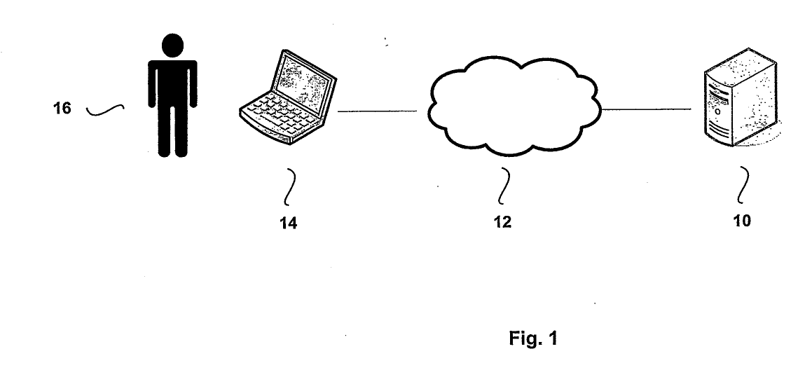

FIG. 1 shows a schematic diagram of a computer system using which a user can estimate the cost of placing an advertisement in a publication. The estimate may be for multiple advertisements over multiple days and in multiple publications. Using the invention this can be achieved online and in real time.

A server 10 hosts the web site through which the service is offered and is a operated (directly or indirectly) by a party such as a license holder. Alternatively, the party may be an advertising agency, a newspaper or a publisher. In this example, the license holder is the intermediary between the user and the publications. The license holder usually gets a percentage return on the value of all advertisements placed with a publication. The server is Windows 2003 and operates through Microsoft Internet Explorer.

Information entered into the website is received by a communication port of the server 10, such as the server's connection to the Internet and then the information is buffered by the server until it is processed according to the invention.

The server 10 includes a data store that includes information specific accessed and stored when using the website.

Stored information specific to the company of the user. This includes one or more templates that is designed in the user's corporate/identity style. For example, it may include the company's logo or any other design features, margins, fonts style, sizes and any other formatting requirements. For example, a template will have a defined margin space and the logo arrangement.

There can be multiple fields for a template, each field having a pre-determined font style, alignment, colour and size. The fields may be defined by the template creator and may vary between templates. For example, there may be a field for heading, sub heading and body text. Templates would also be stored for a range of column widths, starting from one column to multiple columns, such as eleven.

The information stored per user also includes the user's annual spend rate. This variable is used when calculating what the estimated cost of an advertisement will be.

This rate remains constant for a given user for any given period. The annual spend rates are reviewed annually or in some cases re-negotiated based on current activity.

The information stored will also include a user name and password. This ensures that only authorised personnel of the company are able to access the stored templates to create artworks and obtain placement cost estimates.

Information is also stored in the data store that is relevant to all registered users. This includes the different publications, the sections in each publication and the corresponding costs for placing an advertisement in that section. This includes also information relating to special placement packages. For example, if a company in Canberra places the same sized advertisement in the Canberra Times on three consecutive days the cheapest of the three placements is at no charge. These type of advertising deals are usually at the discretion of the publisher.

The server also includes a processor to create artwork from the text entered into the input fields and using the stored template. The artwork may be stored in PDF format. The processor is also used to calculate the estimated costs of placing an advertisement.

The server 10 is connected to the Internet 12. The website can be accessed using a computer 14 of a user 16 that is also connected to the Internet 12 using a software application such as Internet Explorer. The user 16 can be any personnel of a company that advertises on a regular basis, such as a recruitment company or a real estate agent.

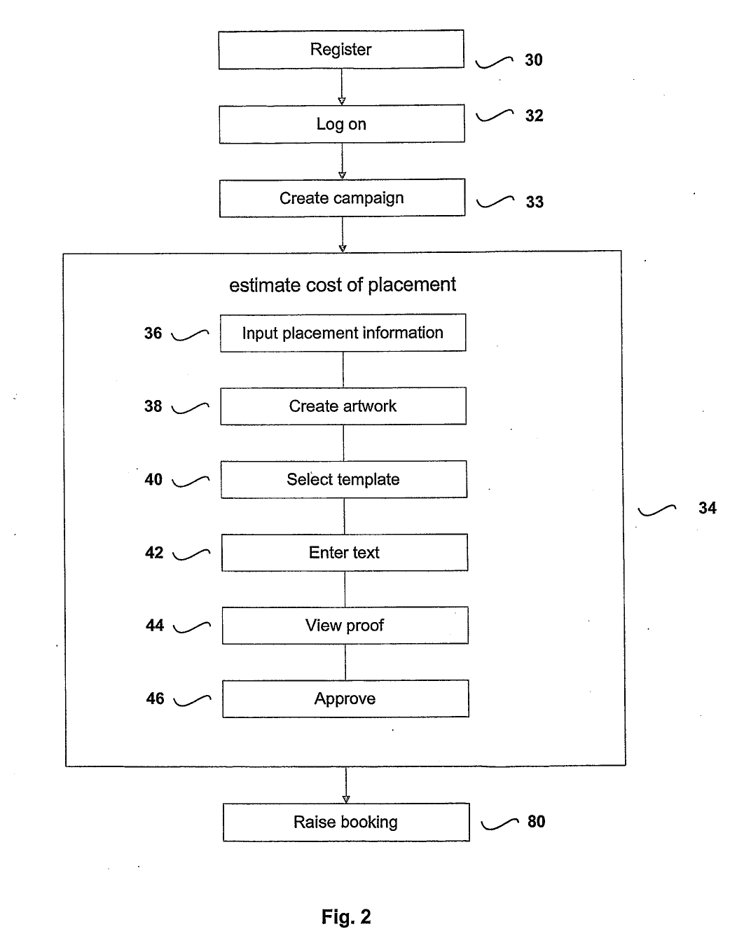

A method of using the invention to estimate the costs of placing an advertisement in one or more publications, and booking the placement of the advertisement will now be described with reference to FIG. 2.

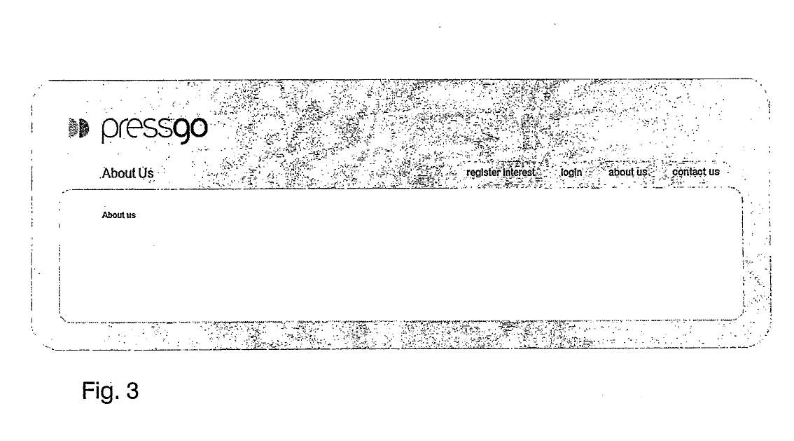

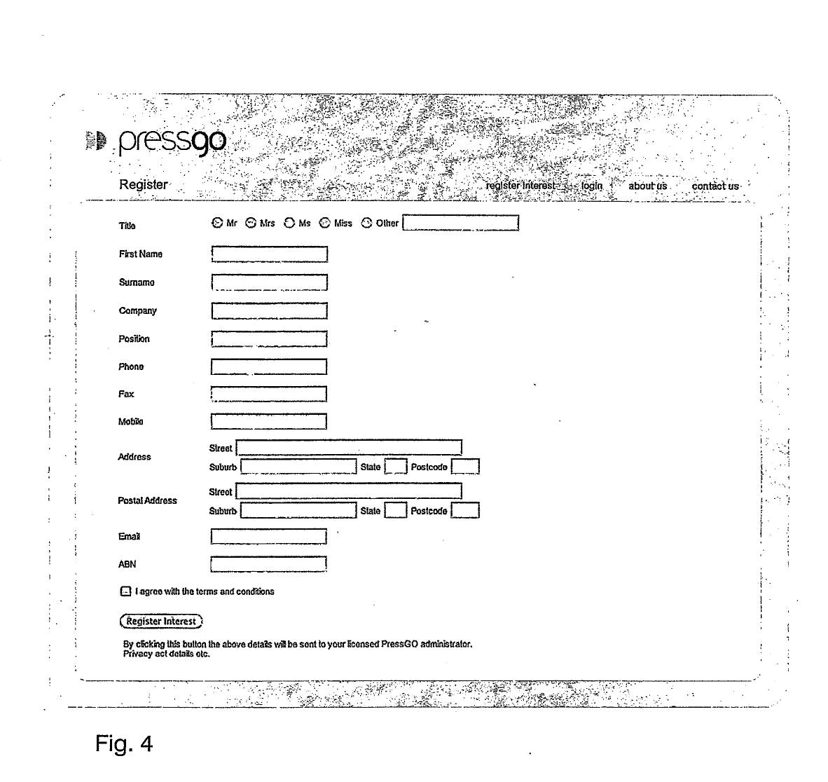

First the user 16 must register 30 with the service offered by the licensed user of the software. This creates a relationship between the user 16 and the license holder. Registration can be made using the website. The user accesses the website using their personal computer 14 and is presented with the display as shown in FIG. 3. To register the user clicks on the “Register Interest” tab and is presented with a new display as shown in FIG. 4. Here the user must enter the required information as set out on the display.

Once registration is approved, templates in the company's corporate style are then created and stored on the server 10. A charge rate is also determined for the user 16 and stored on the server 10. The user is provided with a user name and password to access the website and this is also stored on the server 10.

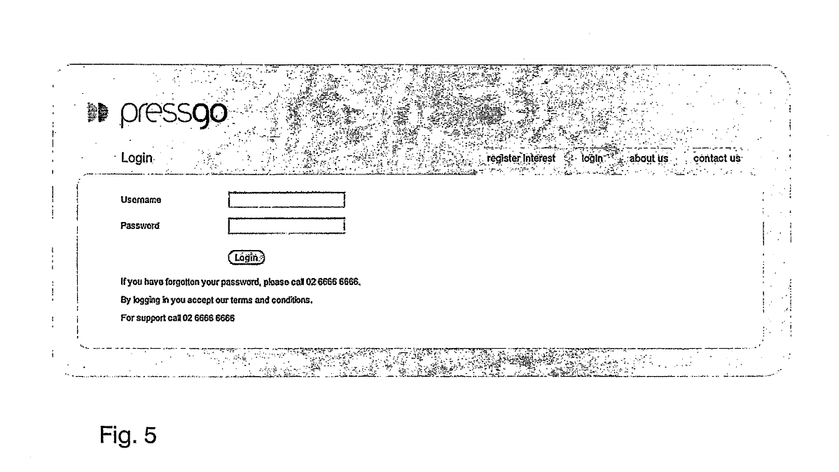

The user can login 32 by clicking the “Login” tab as shown in FIG. 3 and then entering their username and password into the screen display shown in FIG. 5.

Once logged in the user 16 is able to navigate to the functions offered by the website.

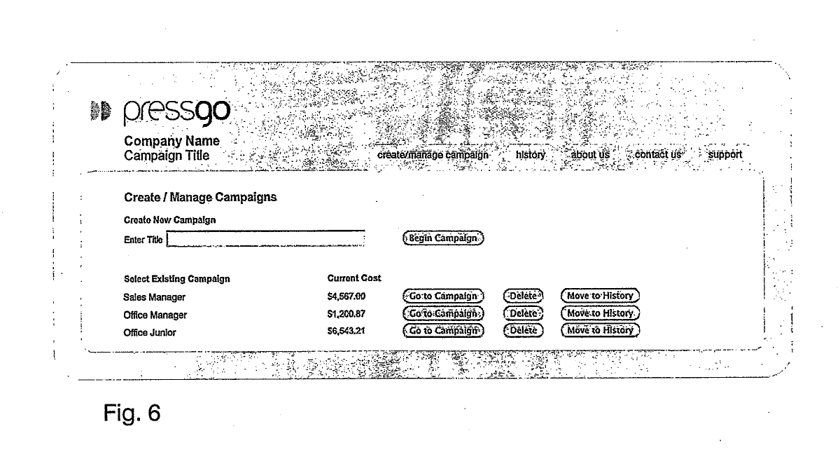

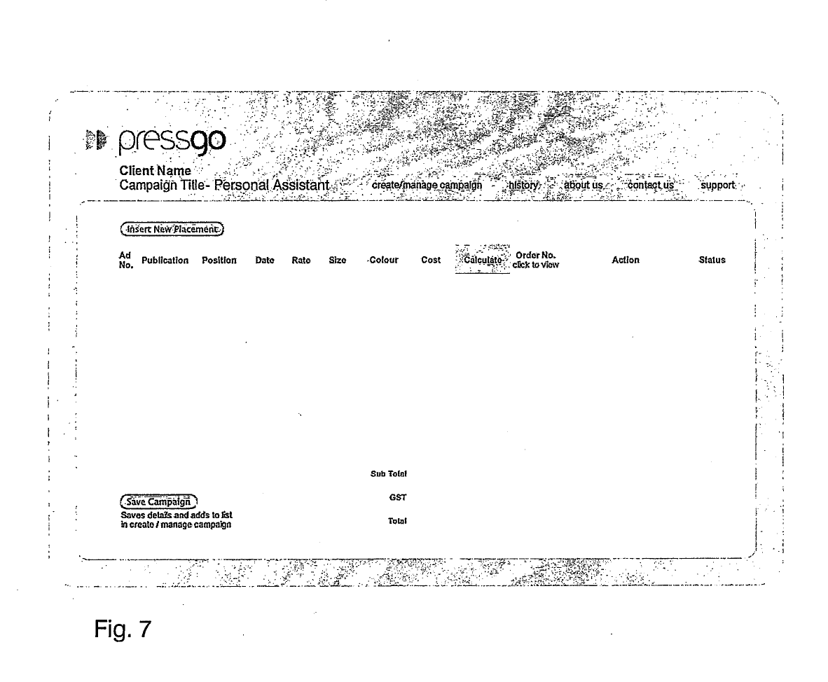

If a campaign has not already been created, the user must create a campaign 33 by clicking on the “Create/Manage Campaign” tab. A further screen is presented as shown in FIG. 6. This shows that three campaigns already exist entitled “Sales Manager”, “Office Manager”, and “Office Junior”. To create a new campaign the user enters a title of the campaign such as “Personal Assistant” and then clicks “Begin Campaign”. This takes the user to the Campaign page as shown in FIG. 7.

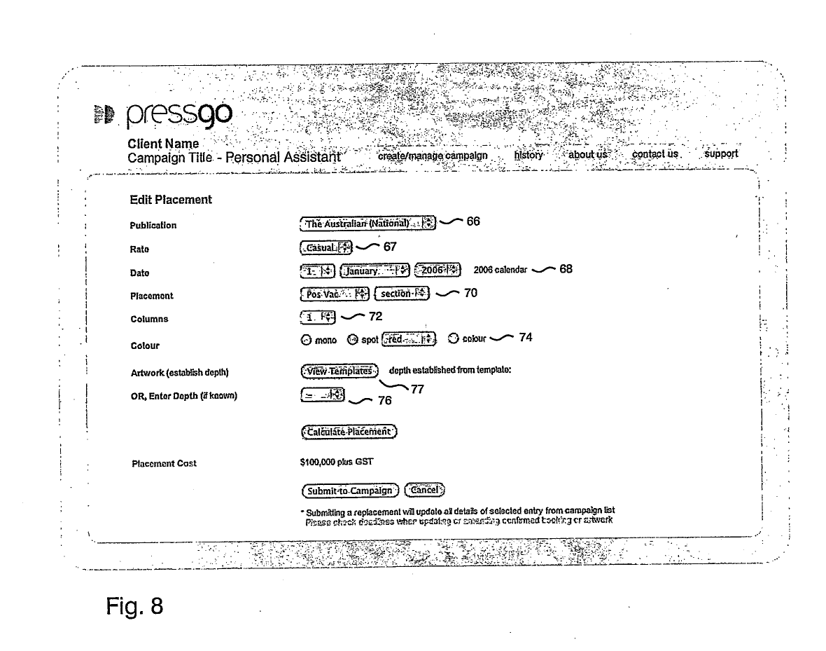

Currently there are no placements of an advertisement included in the campaign. By clicking on “Insert New Placement” this directs the user to the screen as shown in FIG. 8.

The user 16 is required to input 36 for this new placement all the information that affects the placement costs. This includes:
the publication that the advertisement is to be placed in 66
the rate 67
the date of the placement 68
the section of the publication 70
the width of the artwork in columns 72
the printing style of the advertisement 74
the depth of the artwork 76

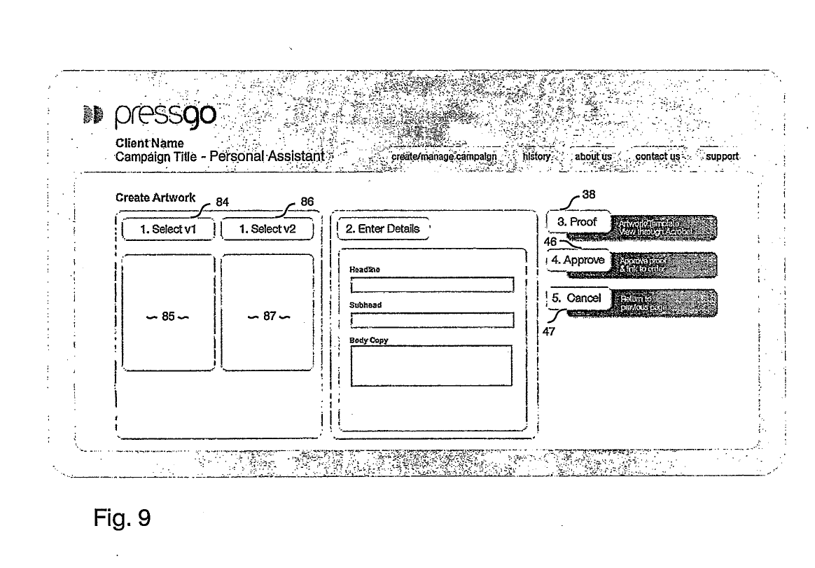

The user 16 is able to enter an assumed depth of the advertisement, or they can establish the depth by clicking on “View Templates” 77 to create 38 the artwork for the placement in real time. This directs the user to the screen shown in FIG. 9. Here the user 16 selects 40 a template for the advertisement. In this case the user 16 is given a choice of either template v1 84 (and there is an example of the template displayed at 85) or template v2 86 (and an example of the template is shown at 87) that are stored on the server 10.

The templates may include different graphics, or it may be the same graphic arranged to suit a different number of columns.

The user 16 also enters 42 the text of the advertisement as they wish it to appear in the corporate style. That is, they enter the text into each of the fields:
headline
subheading
body text
contact details

The types and number of fields that the user 16 has to enter will depend on the template that is selected.

From this screen the user 16 can view a proof 38 of the advertisement. By clicking on the “Proof” 38 box the server 10 processes the text entered into the fields and creates artwork advertisement according to the template selected. The artwork is presented as an image of the advertisement, for example an instance of Adobe Acrobat Reader may open showing the artwork. The PDF file of the artwork is then stored on the server 10. Any layout decisions made by the server 10 are decided in a manner that is most cost efficient (i.e. shortest in depth to the nearest mm, 0.5 cm or 1 cm).

The artwork is also automatically adjusted to suit the actual width the advertisement is required to be in the publication since the column width for different publications are not always the same. For example, a template could be chosen that is for two columns and is intended for publication in the Canberra Times and in The Australian. In the Canberra Times the column width is 76 cc for two columns and in The Australian the column width is 70 cc for two columns. The invention automatically adjusts the artwork in width to be the required width for each specific publication.

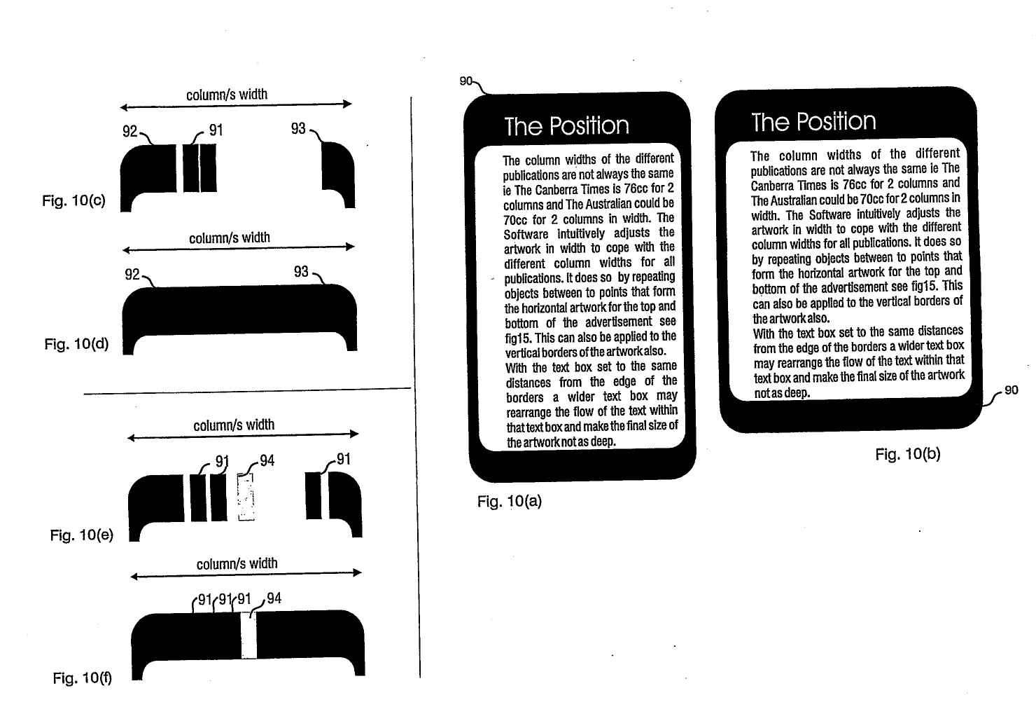

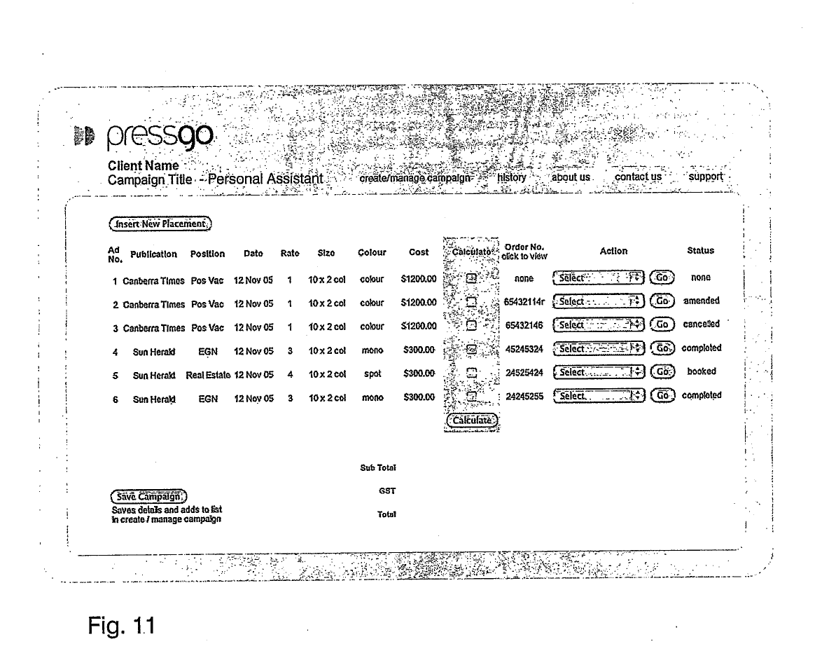

The method of automatically adjusting the width of an artwork will be described with reference to FIGS. 10(a) to (f). As shown in FIG. 10(a) and 10(b), the template includes the graphic of a boarder 90. Referring now to FIG. 10(c) it can be seen that a padding object 91 is used that can be repeated between predetermined anchor points 92 and 93 that form the horizontal artwork for the top of the advertisement. The padding graphic is a small vertical slice through a uniform part of the graphic. Padding graphics are added as shown in FIG. 10(d) until the required width is reached. Alternatively, if a graphic included the padding graphic and was too long, the padding graphic could be removed until the desired length was achieved. Some padding graphics may be overlapped to reach the required width.

The template is designed so that the text of the advertisement is a predetermined distance from the edge of the boarder. FIGS. 10(a) and (b) show how the depth of the artwork is automatically adjusted as the text is used to fill the different widths between the boarders.

The method of padding out a graphic may be applied when the anchors are not the corners, but say a centre graphic 94 as shown in FIG. 10(e). In this case the padding graphic 91 would be added to either side of the centre anchor 91 until the desired length with was achieved as shown in FIG. 10(f).

In some templates a graphic may extend along the depth of the artwork. In this case, the amount of text determines the depth of the artwork. The graphic of the artwork could be extended to span the required depth by adding or removing the padding graphic in the same way as described above, but adding the padding along the depth of the artwork. In this case, the padding graphic would be a horizontal slice of the graphic.

Now that the artwork of the advertisement has been created, the depth of the artwork can be confidently used to establish the placement costs of the advertisement within selected publication(s).

As shown in FIG. 9, the user 16 can approve 46 the artwork created and they are then re-directed to the screen of FIG. 8 and the artwork is stored on the server 11 ready for delivery to the publisher.

Otherwise, the user 16 may select to return 47 to the screen of FIG. 8 without first approving the artwork. In this way, the user 16 can proceed to get an estimate for the publication of the artwork without formal approval of the artwork.

With the artwork created or approved an estimated cost of the placement 34 is calculated by clicking “Calculate Placement” in FIG. 8. The depth and the cost of the advertisement are automatically entered into their respective fields. The cost for a publication placement could be calculated as:
the width of the advertisement*the depth of the advertisement measured from the artwork created*the annual spend rate of the company.
add 15% for colour on the base rate
add 15% to 25% for page preference loading

A total is also presented to the user 16, which in this case is $1000.00 plus GST.

The user 16 may now submit the advertisement to the campaign or cancel the order. By clicking “Submit to Campaign” the advertisement returns the user 16 to the campaign page. An example page is shown in FIG. 10. Here there are 6 advertisements listed. For each advertisement it shows the summary of the advertisement, the cost, the order number, and status. The status is updated at predetermined intervals and can be:
“amended” meaning that the advertisement has been amended by the user since original creation
“cancelled” meaning the user has removed it from the campaign
“booked” meaning that the advertisement artwork has been given to the publisher and booked for print
“completed” meaning that the advertisement has already gone to print.

From here the user 16 may select to raise a booking order 80. To book the first advertisement listed on FIG. 10 the user selects from the Action pick list “Deliver Artwork”. This confirms with the license holder that the artwork is correct and ready to be sent to the publisher.

The license holder now confirms that publication of the advertisements with the selected publications are possible.

Alternatively, the user 16 may choose from the Action pick list the action “Delete” which will remove the advertisement from the campaign.

It will be appreciated by persons skilled in the art that numerous variations and/or modifications may be made to the invention as shown in the specific embodiments without departing from the spirit or scope of the invention as broadly described.

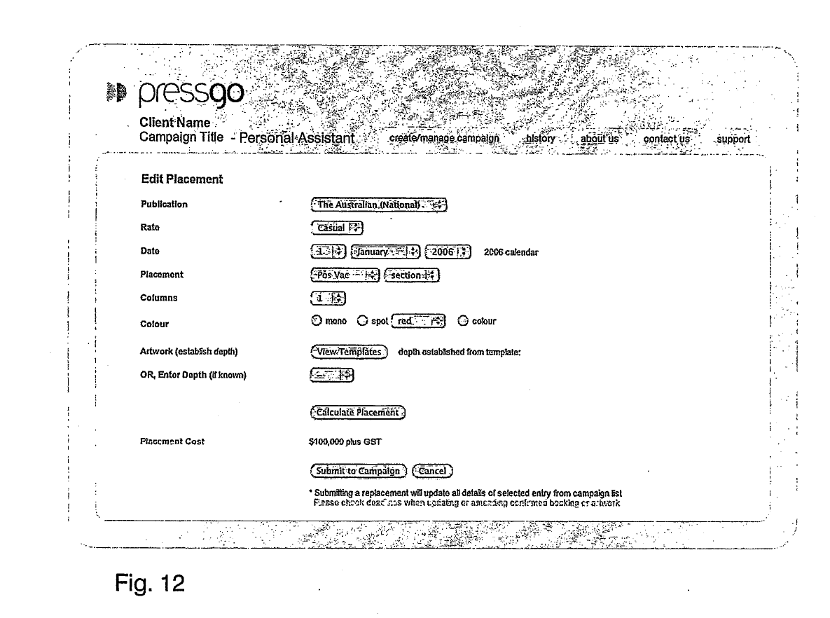

For example, the user may obtain an estimate as described in reference to FIG. 8. However, the content of the advertisement may change so the user may select the action “Edit” for the particular advertisement in FIG. 10. The user can simply amend the artwork by amending the text entered into the fields in the new page that is displayed as shown in FIG. 12. The depth of the artwork may be different as a result of the changes. They may also choose an alternate template that has a different column width. These changes cause the estimate shown in FIGS. 8 and 10 to be automatically recalculated. All adjustments can be made to an advertisement that has a status of “delivered” provided that the booking deadline for the publication has not passed. After the booking deadline has passed adjustments can only be made if it does not affect the dimensions of the booked advertisement.

The screen of FIG. 10 can also be used to provide a cost benefit analysis of various placements in various publications. To include or exclude an advertisement from the current total estimate the user can simply select or unselect the calculate checkbox of an advertisement. The user then clicks “Calculate” to obtain a total for that selected combination of advertisements.

Further, if one of the publication's material deadline is later than the others within the current campaign of FIG. 8 the user can simply select the action “Deliver Artwork” of the advertisements that have the earlier deadline and simply leave the remaining advertisements pending.

The invention can be extended to be used to create the artwork for various business stationary, such as letter head and business cards. In this case, the estimated costs would be based on data entered relating to the number of copies required.

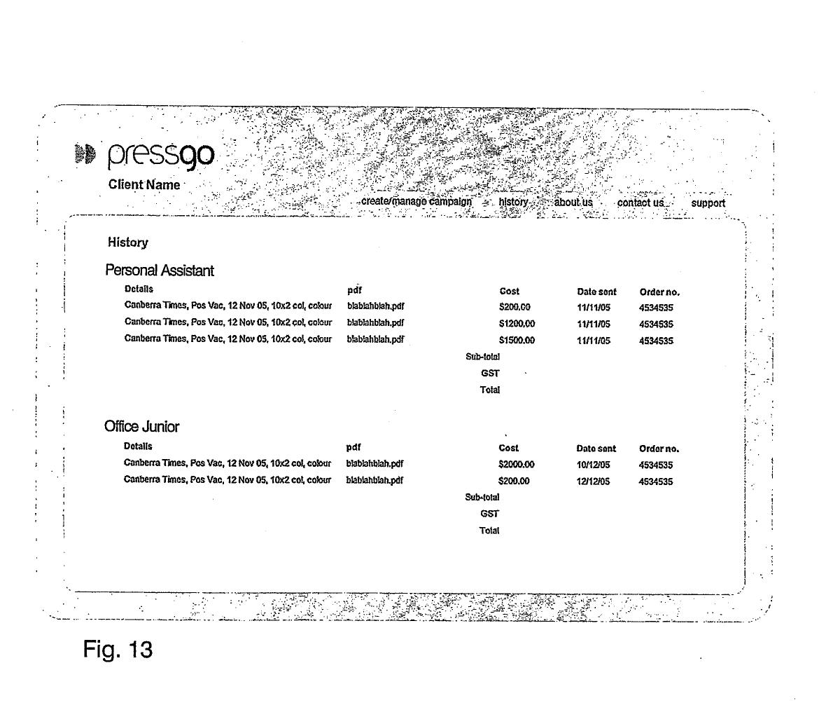

The invention can also be used to review the past advertisements printed using the website by clicking on the “History” tab. A page is displayed as shown in FIG. 13 that summarises the printed advertisements for the two campaigns Personal Assistant and Office Junior. It includes the details of the advertisement, the name of the PDF document of the artwork, the cost, the date it was sent to the publisher and the order reference number.

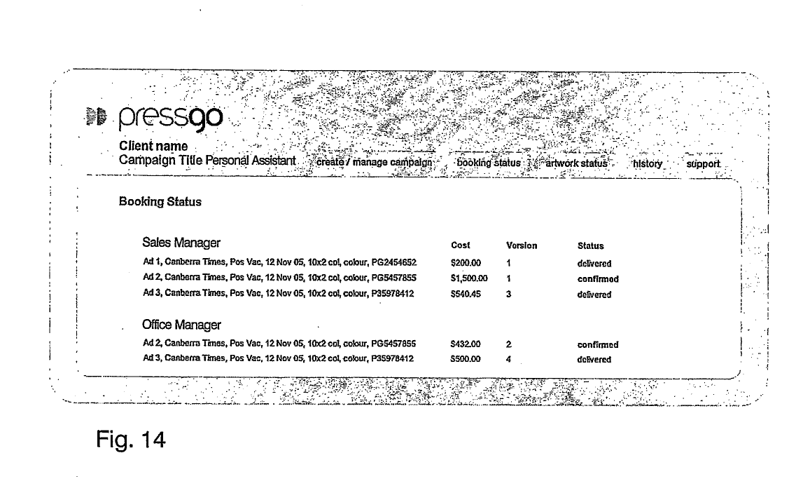

Similarly, the website can be used to summarise the booking status of advertisements that have been confirmed through the website as shown in FIG. 14. This shows the details of the advertisement, the cost, the version (i.e. number of amendments) made to the artwork and the status. The status can be “delivered” which means that the advertisement has been delivered to the publisher. The status can also be “confirmed” which means that the publisher has confirmed that the advertisement will be published as requested.

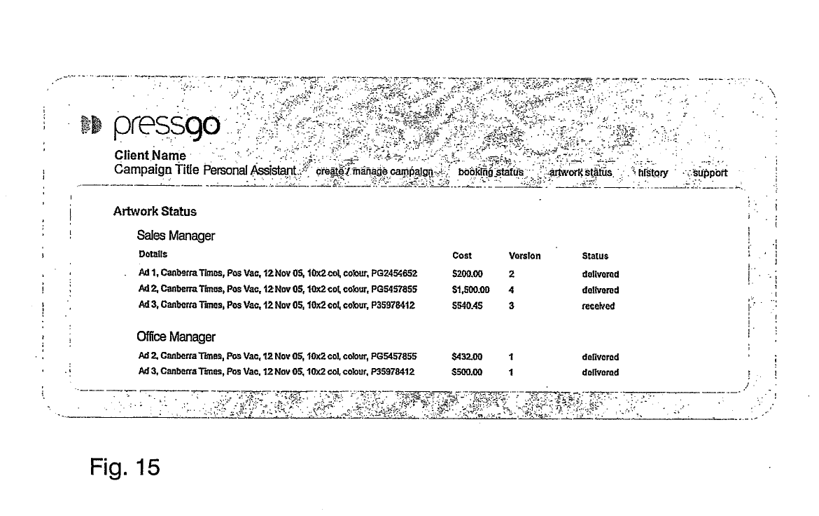

Also, the artwork status can be summarised and displayed as shown in FIG. 15. This shows the details of the advertisement, the cost, version of the artwork and the status. Here the status can be “delivered” which means that the artwork has been delivered to the publisher and “received” meaning that the artwork has been received and stored on the server but has not as yet been sent to the publisher.

The present embodiments are, therefore, to be considered in all respects as illustrative and not restrictive.

1. A method of estimating the cost of a placement of an advertisement in a publication, the method comprising the steps of:
receiving from a user text to be included in the advertisement;
receiving an indication that a stored template specific to the user is to be used to create the artwork for the advertisement;
receiving an indication of the publication that the advertisement is to be placed in;
automatically creating the artwork by arranging the text in the template; and
using the depth dimension of the artwork created to calculate the estimate of the cost of placing the advertisement in the publication.

2. The method according to claim 1, wherein the method further comprises the steps of:
receiving amended text to be included in the advertisement;
automatically creating an amended artwork by arranging the amended text in the template; and
using the depth dimension of the created amended artwork to calculate an amended estimate of the cost of placing the advertisement in the publication.

3. The method of claim 1, wherein the method is repeated to create a further artwork of a further advertisement and to calculate a further estimate of the cost of placing the further advertisement in the same or a different publication, and calculating a total estimate of the cost of the placement of the advertisement and the further advertisement.

4. The method of claim 1, wherein the method further comprises the step of receiving a booking order for placing the advertisement in the publication.

5. The method of claim 1, wherein the step of receiving an indication of a stored template comprises receiving a selection of two or more stored templates.

6. The method of claim 1, wherein the method further comprises the step of upon request, automatically sending the artwork to the requestor for proofing.

7. The method of claim 1, wherein the step of automatically creating the artwork may comprise automatically increasing the depth dimension of the created artwork as the amount of the received text substantially increases.

8. The method of claim 1, wherein the method further comprises using the width dimension of the artwork in the calculation of the estimate.

9. The method of claim 1, wherein the step of automatically creating the artwork comprises automatically adjusting the width of the artwork to suit the actual width of the advertisement in the publication.

10. The method of claim 1, wherein the step of automatically creating the artwork comprises automatically lengthening or shortening a graphic that extends the depth and/or width of the artwork.

11. The method according to claim 10, wherein lengthening or shortening the graphic comprises adding or removing a padding object, or by overlapping padding objects.

12. The method of claim 1, wherein the method further comprises the step of receiving an indication of the publication includes receiving a selection of the publication from a list of publications.

13. The method of claim 1, wherein the method further comprises receiving amended publication information and automatically calculating an amended estimate of the cost of placing the advertisement in the amended publication using the amended publication indication.

14. Software installed on a computer to perform the method described in claim 1.

15. A web site operable to provide an estimate of the cost of a placement of an advertisement in a publication in accordance with the method of claim 1.

16. A computer system operable to estimate the cost of a placement of an advertisement in a publication, the computer system comprising:
storage means to store one or more templates to be used to create the artwork for the advertisement;
a communication port to receive text from a user to be included in the advertisement, to receive an indication that a stored template specific to the user is to be used to create the artwork for the advertisement, and to receive an indication of the publication that the advertisement is to be placed in; and
a processor to automatically create the artwork by arranging the text in the template and to use the depth dimension of the artwork created to calculate the estimate of the cost of placing the advertisement in the publication.

17. The computer system according to claim 16, wherein the communication port further operates to receive amended text to be included in the advertisement; and the processor further operates to automatically create an amended artwork by arranging the amended text in the template, and to use the depth dimension of the created amended artwork to calculate an amended estimate of the cost of placing the advertisement in the publication.

18. The computer system according to claim 16, wherein the computer system further operates to create a further artwork of a further advertisement and to calculate a further estimate of the cost of placing the further advertisement in the same or a different publication, wherein the processor further operates to calculate a total estimate of the cost of the placement of the advertisement and the further advertisement.

19. The computer system of claim 16, wherein the communication port further operates to receive a booking order for placing the advertisement in the publication.

20. The computer system of any one of claims claim 161, wherein the indication of a stored template is a selection of one template from a plurality of templates stored on the storage means.

21. The computer system of claim 16, wherein the communication port further operates to receive a request to create the artwork; and the processor automatically operates to create and send from the communication port the artwork for proofing.

22. The computer system of claim 16, wherein to automatically create the artwork the processor operates to automatically increase the depth dimension of the created artwork as the amount of the received text substantially increases.

23. The computer system of claim 16, wherein the processor uses the width dimension of the artwork in the calculation of the estimate.

24. The computer system of claim 16, wherein to automatically create the artwork the processor operates to automatically adjust the width of the artwork to suit the actual width of the advertisement in the publication.

25. The computer system of claim 16, wherein to automatically create the artwork the processor operates to automatically lengthen or shorten a graphic that extends the depth and/or width of the artwork.

26. The computer system of claim 25, wherein the processor operates to lengthen or shorten the graphic comprises the addition or removal of a padding object, or by overlapping padding objects.

27. The computer system of claim 16, wherein the indication of the publication includes a selection of the publication from a list of publications.

28. The computer system according to claim 16, wherein communication port further operates to receive amended publication information; and the processor operates to automatically calculate an amended estimate of the cost of placing the advertisement in the amended publication using the amended publication indication.
